(19) United States
(12) Patent Application Publication
(10) Pub. No.: US 2024/0084212 A1
(43) Pub. Date: Mar. 14, 2024

(54) AQUEOUS COATING COMPOSITION AND USE THEREOF

(71) Applicant: Ewald Dörken AG, Herdecke (DE)

(72) Inventors: Reiner Wark, Wuppertal (DE); Nicole Matthée, Herdecke (DE); Angela Kleinkorres, Wetter (DE); Hanna Smoll, Schwerte (DE); Anastasia von Rhein, Nachrodt-Wiblingwerde (DE); Martin Kunka, Bergkamen (DE); Marcel Roth, Düsseldorf (DE); Gerhard Reusmann, Essen (DE); Emre Kocak, Lüdenscheid (DE); Ingo Klüppel, Herdecke (DE)

(73) Assignee: Ewald Dörken AG, Herdecke (DE)

(21) Appl. No.: 18/458,562

(22) Filed: Aug. 30, 2023

(30) Foreign Application Priority Data
Sep. 2, 2022 (EP) 22193722.0

(51) Int. Cl. C10M 169/04; C10M 103/06; C10M 105/76; C10M 107/04; C10M 107/28; C10M 111/04; C10M 125/04

(52) U.S. Cl. CPC C10M 169/04; C10M 103/06; C10M 105/76; C10M 107/04; C10M 107/28; C10M 111/04; C10M 125/04; C10M 2201/05; C10M 2201/123; C10M 2205/0225; C10M 2209/0845; C10M 2227/045; C10N 2050/02

(57) ABSTRACT

A coating composition for producing a coating with an adjustable coefficient of friction.

This application claims the benefit of European Patent Application No. EP 22193722.0, filed Sep. 2, 2022, which is incorporated herein by reference in its entirety.

### FIELD

The present invention relates to the technical field of coatings, in particular coatings for mass bulk materials.

### BRIEF DESCRIPTION OF THE DRAWINGS

FIG. 1 is a list of the coefficients of friction of screws which have been coated with a zinc flake coating and subsequently with a topcoat according to the invention.

FIG. 2 is a list of the coefficients of friction of screws coated with a zinc flake coating and a commercially available topcoat containing PTFE.

### DETAILED DISCLOSURE

In particular, the present invention relates to an aqueous coating composition for producing a coating with an adjustable coefficient of friction. Further, the present invention relates to a method for producing a coating with an adjustable coefficient of friction and to the use of an aqueous coating composition for producing a coating with an adjustable coefficient of friction. Finally, the present invention relates to a coated substrate.

Fasteners, in particular small parts such as bolts, nuts and screws, which are used for mechanical fastening of components, in particular metal components, must comprise reproducible specific coefficients of friction so that they can be processed industrially.

The coefficient of friction μ, also known as the frictional coefficient, indicates the ratio of frictional force to normal force; the higher the frictional coefficient, the higher the frictional force. The higher the frictional force, the less energy goes into the elastic or plastic elongation of the screw in the tightening process, resulting in a reduced so-called preload force. The preload force is usually specified to ensure reliable performance of the bolted joint, which is why the coefficient of friction must move within a defined window. This is of particular importance in the case of fastening materials such as bolts, screws, nuts or even rivets, since these are used for the purely mechanical fastening of components. On the one hand, the friction must be sufficiently high to prevent unintentional loosening of the compound, but at the same time it must be low enough to allow a complete and substance-to-substance bond.

In addition, the coefficients of friction must be set as constantly as possible to allow industrial processing, in particular using robots, for example for screws with a defined torque or for bolt rivets with always the same force. For this reason, small fastening parts are often coated in practice with special coating compositions in the form of topcoats, which are intended to set and influence the sliding and frictional properties of the parts in a desired manner.

The desired sliding and friction properties of screws or bolts are usually determined in accordance with DIN EN ISO 16047:2013-01, wherein a window of coefficient of friction μ of 0.09 to 0.16 is specified specifically for screws by the German Association of Automotive Manufacturers (VDA).

In order to set the desired coefficients of friction, particular topcoat compositions usually contain fluorinated plastic particles, in particular based on polyfluorotetraethylene (PTFE) or polyvinylidene fluoride (PVDF).

However, the use of per- or partially fluorinated compounds has several serious disadvantages: on the one hand, fluorinated polymers are relatively expensive, and on the other hand, they are better avoided from the point of view of environmental protection. During the producing of fluorinated compounds, in particular PTFE, not inconsiderable amounts of perfluorooctanoic acid (PFOA) are usually produced or used for the producing of these compounds. Perfluorooctanoic acid is virtually non-degradable in nature, accumulates in living organisms and comprises in particular liver-damaging, reproduction-toxic and carcinogenic properties. The producing of perfluorooctanoic acid and its precursor compounds has therefore been banned in the European Union since Jul. 4, 2020, with a few exceptions.

In addition, the producing or use of PTFE also produces polyfluorinated by-products and degradation products, which must not be released into the environment if possible.

For this reason, there are efforts to replace polyfluorinated plastics with other materials wherever possible. However, this replacement is often not easy, since polyfluorinated or perfluorinated plastics comprise special and sometimes outstanding properties, in particular with regard to their hydrophobic wetting or non-wetting properties, their resistance to chemical and physical influences, and their excellent sliding properties.

One problem that arises in particular with screwed joints is heat release behavior, since the sliding properties of many plastics change at elevated temperatures. In particular, the sliding properties of many plastics improve when heated. However, this is undesirable for screwed joints, as there is otherwise a risk of unintentional joint loosening. Perfluorinated plastics, in particular PTFE and PVDF, do not exhibit this problematic behavior, or only to a limited extent, so that they are still the material of choice today for setting the sliding or frictional properties of fasteners in a targeted manner. PTFE is characterized in particular by its high melting point, which allows friction behavior to be optimized in higher temperature ranges.

Another problem, which occurs in particular when screws are tightened at high speeds, is the so-called stick-slip effect. In this case, the screw no longer moves smoothly during tightening, but instead starts to stick and slide. This results in a torque uncertainty on the one hand and a preload uncertainty on the other, which in turn can lead to a hidden risk of failure during operation. Stick-slip effects should therefore be avoided wherever possible, which is why the sliding and adhesive properties of bolts must be set particularly accurately and uniformly. So far, stick-slip effects can only be largely prevented by using topcoats containing fluoropolymers

One disadvantage of fluorinated polymers, however, is that they should preferably be used in solvent-based systems because of their hydrophobicity. For environmental and occupational safety reasons, however, aqueous systems are increasingly preferred.

Another problem is that the coefficient of friction values are often subject to wide variation even when fluoropolymer topcoats are used, i.e., for example, the coefficients of friction of individual screws coated with the same topcoat differ greatly from each other. In this case, a topcoat that limits the scatter of the coefficient of friction values to a smaller range would be desirable in order to further increase the quality of bolted joints.

Up to now, the state of the art has lacked an aqueous coating system that allows the friction coefficients of small fasteners in particular to be set in a targeted manner and that manages without the use of fluorinated polymers, preferably entirely without the use of fluorinated polymers, and does so while meeting the requirements for the narrowly defined friction coefficient window, heat release and stick-slip behavior.

One object of the present invention is thus to provide a coating composition which permits precise setting of the coefficients of friction of components, in particular fastening components, such as in particular screws, nuts, bolts or rivets, and which moreover manages without the use of PTFE and preferably dispenses entirely with fluorinated polymers.

Furthermore, it is an object of the present invention to provide a coating system which is at least largely free of organic solvents and is preferably free of organic solvents.

A further object of the present invention is to provide a coating system which largely prevents stick-slip effects.

Finally, an object of the present invention is to minimize the dispersion of the coefficient of friction.

Thus, the subject-matter of the present invention according to a first aspect of the invention is an aqueous coating composition according to claim 1; further advantageous embodiments of this aspect of the invention are the subject-matter of the related dependent claims.

Again, another subject-matter of the present invention according to a second aspect of the present invention is the use of a coating composition according to claim 13.

Again, further subject-matter of the present invention according to a third aspect of the present invention is a method for producing a coating according to claim 14; further, advantageous embodiments of this aspect of the invention are the subject-matter of the related dependent claim.

Finally, a further subject-matter of the present invention according to a fourth aspect of the present invention is a metallic substrate according to claim 16; further advantageous embodiments of this aspect of the invention are the subject-matter of the related dependent claims.

It goes without saying that special features, characteristics, embodiments and advantages or the like which are set forth below—for the purpose of avoiding unnecessary repetition—with respect to only one aspect of the invention, naturally apply accordingly with respect to the other aspects of the invention without the need for express mention.

In addition, it applies that all value or parameter data or the like mentioned in the following can in principle be determined or determined with standardized or explicitly stated determination methods or with determination methods which are familiar to the person skilled in the art in this field.

Furthermore, it goes without saying that all weight- or quantity-related percentages are selected by the person skilled in the art in such a way that the total results in 100%.

With this proviso stated, the present invention will be described in more detail below.

Thus, the subject-matter of the present invention—according to first aspect of the present invention—is an Aqueous coating composition for producing a coating, in particular a topcoat, with an adjustable coefficient of friction, wherein the composition comprises
(a) an organic and/or inorganic binding agent,
(b) a lubricant in amounts of at least 1.3 wt. %, based on the coating composition, and
(c) platelet-shaped particles.

For, as the applicant has surprisingly found out, aqueous coating compositions for topcoats with specifically adjustable coefficients of friction can be obtained on the basis of commercially available organic or inorganic binding agents if at least one lubricant in defined quantities and platelet-shaped particles are added to the compositions. Particularly good results are obtained if mixtures of organic and inorganic binding agents are used. The compositions according to the invention are in particular free from fluorinated polymers, especially PTFE.

Surprisingly, the coating compositions according to the invention show comparable sliding and frictional properties after curing to the topcoat as PTFE-containing topcoat compositions, wherein, however, the variation of the measured coefficient of friction values of coated fasteners, such as screws, is significantly lower than with the fluorinated, in particular PTFE-containing, coating compositions used so far in the prior art.

Furthermore, the topcoat systems according to the invention show consistent coefficients of friction even at high temperatures, in particular high drying temperatures. This is surprising because lubricant-containing topcoats, in particular in the case where they contain waxes, comprise a higher coefficient of friction after exposure to temperature. In particular, this is due to the fact that the lubricants, in particular waxes, pass into the gas phase or are thermally decomposed during the drying process. Surprisingly, topcoats containing platelet-shaped particles in addition to a lubricant do not show this increase in the coefficient of friction. Without wishing to be bound to a theory, this is probably due to the fact that the platelet-shaped particles act as a diffusion barrier and, on the one hand, retard the penetration of oxygen into the coating and thus slow down decomposition of the lubricant and, on the other hand, when evaporable or sublimed lubricants are used, prevent the lubricant from passing into the gas phase.

The coating compositions according to the invention thus permit a much more precise setting of the coefficient of friction with, in particular, a significantly lower variance than the PTFE-containing topcoat compositions used to date. This effect is particularly pronounced if a mixture of organic and inorganic binders is used, in particular if the organic binder is an acrylate-based binder, i.e. configured on the basis of acryl or polyacrylate or copolymers thereof, wherein acrylate is preferred, and the inorganic binder is a silicon-containing binder, as will be explained below.

The coating compositions according to the invention can be readily formulated in aqueous medium and, moreover, may be free of PTFE. Preferably, they are even entirely free of fluorinated polymers.

The present invention thus provides easy access to topcoats whose coefficients of friction can be set to values required for industrial production, in systems which are both solvent-free and free of fluorinated polymers, in particular free of PTFE. The coating composition according to the invention is thus superior both from an environmental point of view and from the point of view of occupational safety to the usually fluoropolymer-containing and solvent-based systems known to date. In addition, substrates coated with the coating composition according to the invention, in particular fastening means such as screws, nuts, bolts, etc., show a significantly lower variance in the coefficient of friction than the PTFE-containing systems used to date.

It has been shown that the sliding properties are significantly improved, and the coefficient of friction can be set stably, in particular even at elevated temperatures, if a lubricant and platelet-shaped pigments are added to the binding agent.

In the context of the present invention, a lubricant is understood to mean a chemical substance or a mixture of substances which changes the tribological properties of a coating, in particular reduces friction. In the context of the present invention, lubricants can be present either in liquid or solid form, wherein the use of solid lubricants is preferential.

In the context of the present invention, a wax is to be understood in particular as a natural or artificially obtained substance which is usually kneadable at 20° C., solid to brittle hard, coarse to fine crystalline, translucent to opaque, but not glassy, and which melts without decomposition at above 40° C. Even slightly above the melting point, a wax is usually relatively low in viscosity and non-threading. Waxes differ from similar synthetic or natural products mainly in that they usually change to the molten, low-viscosity state between about 50 and 90° C., in exceptions up to about 200° C., and are practically free of ash-forming compounds. Waxes form pastes or gels and usually burn with a sooty flame. According to their origin, waxes are divided into three groups, namely natural waxes, semi-synthetic waxes and synthetic waxes. Natural waxes consist in particular of vegetable waxes, such as candelilla wax, carnauba wax or montan wax, animal waxes, such as beeswax, lanolin and brushing fat, mineral waxes, such as ceresin and ozokerite, and petrochemical waxes, in particular petrolatum, kerosene waxes and microwaxes. Semi-synthetic waxes are in particular hard waxes, such as montan ester waxes and hydrogenated jojoba waxes. Synthetic waxes are, for example, polyalkylene waxes or polyethylene glycol waxes.

In the context of the present invention, platelet-shaped particles, which are also often referred to as flaky particles, are understood to be particles whose thickness is significantly less than their length and width, i.e. whose extension in one spatial direction is significantly less than in the other two spatial directions. Usually, the aspect ratio, i.e. the ratio of the length or width of the particles to the thickness of the particles is in the range of 2:1 to 100:1, in particular 4:1 to 50:1, preferably 5:1 to 20:1, preferably 8:1 to 15:1.

As previously stated, it is essential in the context of industrial production, in particular screw fastening by robots, that the sliding properties or coefficients of friction of coated fasteners, in particular screws, always assume comparable values in a reproducible manner. For this reason, VDA Guideline 235-101 defines a so-called friction coefficient window in which the coefficient of friction μ for fastening means, in particular bolts, nuts and screws, may lie. This friction coefficient window covers an interval of the friction coefficient μ of 0.09 to 0.16. The friction coefficient is determined in accordance with DIN EN ISO 16047:2013-01. If other friction coefficient windows are defined and desired, these can also be fulfilled by the invention described herein.

Within the scope of the present invention, it is preferred if the surface or coated substrate coated with the coating composition according to the invention comprises a coefficient of friction determined according to DIN EN ISO 16047:2013-01 in the range from 0.09 to 0.16.

In the case of screws, the coefficient of friction is determined both on the thread and on a flat surface, in particular the head of the screw. This dual determination is necessary because workpieces, in particular threaded parts, comprise a different coefficient of friction at the thread than at flat coated surfaces, such as the head of a screw. For example, screws that are designed as internal supports have a higher coefficient of friction at the thread and thus poorer sliding properties than at the head of the screw, which rests on a nut or threaded washer. If the screw is an outer carrier, the coefficient of friction is higher at the head than at the thread.

Since the coefficient of friction measurement for both areas (thread and flat surface) are included in the coefficient of friction determination for the entire workpiece, workpieces coated with a coating without lubricant often comprise an undesirably high coefficient of friction, so that, for example, additional lubricants must be used in joining processes. According to the invention, however, the use of lubricants can be dispensed with.

Within the scope of the present invention, it is preferably provided that for threaded parts, such as screws, the coefficient of friction for both the thread and the flat surface each lie within the aforementioned coefficient of friction window of the coefficient of friction μ of 0.09 to 0.16.

Since the test regulation mentioned in DIN EN ISO 16047:2013-01 applies to a single tightening, a test arrangement for a multiple tightening is additionally specified in the test sheet according to VDA 235-203.

Within the scope of the present invention, it is preferably further provided that the above-mentioned friction coefficient window for the coefficient of friction μ of 0.09 to 0.16 is also fulfilled in the case of a multiple tightening, both on the thread and on flat surfaces.

In addition, the hot loosening behavior of workpieces, in particular fasteners such as screws or bolts, is also critical, in particular if these are installed in the vicinity of aggregates such as engines. For this reason, VDA test sheet 235-203 defines a test arrangement at temperature load at 150° C., wherein a coefficient of friction μ of 0.06 must not be undershot.

Within the scope of the present invention, it is therefore preferred if the workpieces coated with the coating composition according to the invention comprise a coefficient of friction μ of not less than 0.06, at 150° C. according to VDA test sheet 235-203. This friction coefficient window is preferably satisfied both for the total friction coefficient and, in the case of threaded workpieces, at the thread and at the flat surface.

As previously disclosed, the coating composition according to the invention contains a binding agent. The amount in which the coating composition contains the binding agent can vary within wide ranges depending on the exact requirements and respective intended use. Typically, however, the coating composition contains the binding agent in amounts of 6 to 40 wt. %, in particular 9 to 33 wt. %, preferably 11 to 27 wt. %, preferred 13 to 22 wt. %, based on the coating composition.

As likewise previously stated, the binding agent may be selected from organic binders, inorganic binders and mixtures thereof. Preferably, the coating composition comprises at least one organic binding agent. Still further preferred in the context of the present invention, the coating composition comprises an organic binding agent and an inorganic binding agent. Thus, it is preferred in the context of the present invention if the coating composition comprises a mixture of organic and inorganic binding agents.

If the coating composition contains organic and inorganic binding agents, then the coating composition may contain the organic binding agent in virtually any amount. However, it has been well proven if the coating composition contains the organic binding agent in amounts of 2 to 20 wt. %, in particular 3 to 15 wt. %, preferably 4 to 12 wt. %, preferred 5 to 10 wt. %, based on the coating composition.

The coating composition preferably contains an inorganic binding agent in addition to the organic binding agent. The addition of an inorganic binding agent in particular increases the wear resistance and mechanical resistance of the coating. In addition, the use of inorganic coatings is also commercially desirable, since they can often be produced or obtained inexpensively on a large industrial scale.

If the coating composition contains organic and inorganic binding agents, it has been well proven if the coating composition contains the inorganic binding agent in amounts of 4 to 20 wt. %, in particular 6 to 18 wt. %, preferably 7 to 15 wt. %, preferred 8 to 13 wt. %, based on the coating composition.

Turning now to the organic binding agent, this can be selected from a variety of suitable binding agents.

Typically, the organic binding agent comprises an organic polymer or consists of an organic polymer. Preferentially, the organic binding agent consists of an organic polymer.

The organic polymer may be selected from the group consisting of acrylates, polyurethanes, polyvinyl acetate and mixtures and copolymers thereof. Preferably, the polymer is selected from the group of acrylates, polyurethanes and mixtures and copolymers thereof, in particular acrylates and acrylate copolymers. Particularly good results are obtained in the context of the present invention if the polymer is an acrylate.

In the context of the present invention, organic binding agents based on acrylates are thus preferably used, in particular pure acrylates, which are often also referred to as polyacrylates or acrylics. Acrylates or polyacrylates or acrylics are polymers of acrylic acid or methacrylic acid or of esters thereof. Acrylic binders are in particular easily formulated in aqueous media and comprise excellent film-forming properties.

In the context of the present invention, it has therefore been well proven if the polymer is obtainable from monomers selected from the group consisting of acrylic acid, esters of acrylic acid with C₁- to C₁₀-alcohols, methacrylic acid, esters of methacrylic acid with C₁- to C₁₀-alcohols, fumaric acid, maleic acid and mixtures thereof. Particularly good results are obtained in this context if the polymer is obtainable from monomers selected from the group consisting of acrylic acid, ethers of acrylic acid with C₁- to C₁₀-alcohols, methacrylic acid and esters of methacrylic acid with C₁- to C₁₀-alcohols and mixtures thereof.

It is still further preferred in the context of the present invention if the polymer is obtainable from monomers selected from the group consisting of acrylic acid, acrylic acid methyl ester, acrylic acid ethyl ester, acrylic acid butyl ester, acrylic acid isobutyl ester, acrylic acid 2-ethylhexyl ester, methacrylic acid, methacrylic acid methyl ester, methacrylic acid ethyl ester, methacrylic acid butyl ester, methacrylic acid isobutyl ester and methacrylic acid hexyl ester. In this context, it is particularly well proven if the polymer is obtainable from monomers selected from the group of acrylic acid, acrylic acid methyl ester, acrylic acid ethyl ester, methacrylic acid, methacrylic acid methyl ester, methacrylic acid ethyl ester and mixtures thereof, preferably acrylic acid, methacrylic acid and mixtures thereof

As far as the molecular weight of the polymer is concerned, this can naturally vary over a wide range. However, it has been well proven if the polymer comprises a weight-average molecular weight Mw in the range of 2,000 to 250,000 g/mol, in particular 5,000 to 200,000 g/mol, preferably 10,000 to 150,000 g/mol, preferred 15,000 to 100,000 g/mol.

The molecular weights for polymeric compounds given in the context of the present invention refer to the weight-average molecular weight Mw, in which the mass of the individual polymeric compounds is weighted by their weight fraction. The molecular weights or molecular weight distribution can be determined by various standardized procedures and methods, such as light scattering, rheology, mass spectrometry, permeation chromatography, etc. However, the methods used to determine the molecular weight distribution are familiar to those skilled in the art and do not require further explanation. For example, the molecular weights of the polymers used can be determined in particular by means of a GPC method, in particular on the basis of DIN 55672 with polymethyl-methacrylate or polystyrene as the standard.

The inorganic binding agent is usually a silicon-containing binding agent.

Preferably, the organic binding agent is selected from silanes, silane hydrolysates, silicates, polysiliconates and mixtures thereof.

Particularly good results are obtained in this context if the inorganic binding agent is selected from the group of silanes, in particular trialkoxysilanes and tetraalkoxysilanes, preferably vinylsilanes, aminesilanes, phenoxysilanes and/or epoxysilanes, tetraethyl orthosilicate (TEOS), tetramethyl orthosilicate (TMOS), silane hydrolysates, colloidal silicic acid, water glasses or silicates, in particular lithium water glass, sodium water glass, potassium water glass and mixtures thereof. In particular, the silanes that can preferably be used are those mentioned below in the producing of silane-modified silicates.

According to a preferred embodiment of the present invention, the inorganic binding agent is in particular free of lithium compounds. In the context of the present invention, particularly good coating and slip properties can be obtained if the lithium polysilicate (lithium water glass), which is usually preferentially used, is dispensed with. This is a particular advantage of the present invention, since the demand for lithium and, subsequently, lithium prices are expected to increase due to the increasing use of lithium ion batteries and lithium ion accumulators, in particular in the automotive sector

Preferably, the inorganic binding agent is selected from the group of silanes, in particular trialkoxysilanes and tetraalkoxysilanes, preferably vinylsilanes, aminesilanes, phenoxysilanes and/or epoxysilanes, tetraethyl orthosilicate (TEOS), tetramethyl orthosilicate (TMOS), silane hydrolysates, colloidal silicic acid (silic sol), sodium water glass, potassium water glass and mixtures thereof. More preferably, the inorganic binding agent is selected from the group of sodium water glass, potassium water glass and mixtures thereof.

According to a preferred embodiment of the present invention, the inorganic binding agent comprises or consists of a mixture of water glass and/or colloidal silicic acid with silane hydrolysate and/or silane. Preferably, the inorganic binding agent comprises a mixture of water glass and/or colloidal silicic acid with silane hydrolysate and/or silane. These mixtures also do not show carbonation at alkaline pH values.

According to this embodiment, it is preferred if the organic binding agent contains the water glass and/or the colloidal silicic acid in a ratio by weight to the silane hydrolysate and/or silane in the range from 15:1 to 1:2, in particular 1:1 to 1:1.5, preferably 5:1 to 1:1, preferred 4:1 to 1:1

Similarly, according to this embodiment, it has been well proven if the inorganic binding agent, in particular before mixing with the organic binding agent, is set to a pH of less than 11, in particular less than 9, preferably less than 8.5. Preferably, the inorganic binding agent, in particular before mixing with the organic binding agent, is set to a pH value of less than 8, in particular in the range from pH 5 to pH 7.5.

In mixtures of water glasses and/or colloidal silicic acids with silane hydrolysates and/or silanes, a significantly weaker or diminished carbonation, i.e. the absorption of carbon dioxide from the air with subsequent production of carbonates, is observed in particular at pH values in the alkaline range. Carbonation leads, in particular in the case of topcoats, to an undesirable impairment of the surface properties, in particular the appearance, due to turbidity of the topcoat. The coatings then often appear dusty, which is not desirable. Another advantage of the mixtures described is that the pH of the inorganic binding agent and/or the coating composition can be set in the acidic range without precipitating the silicate or silicic acid.

Particularly good results are obtainable in this context if the inorganic binding agent is a silane-modified silicate compound or a silane-modified water glass. The silane-modified silicate compound or silane-modified water glass is usually obtainable by at least partially hydrolyzing and/or condensing at least one silane in the presence of at least one silicate at a pH equal to or greater than 8.

Similarly, when silane-modified silicate compounds or silane-modified water glasses are used, no carbonation is observed and the pH of the inorganic binding agent or coating composition can be set to values of less than or equal to 7 without precipitation of the silicate. In this case, the pH can be adjusted by adding acids. Use of the silane-modified silicate compounds or the silane-modified water glasses in the neutral or acidic pH range is preferred, in particular because the absorption of carbon dioxide in the form of carbonates is significantly reduced in the acidic range.

Preferably, the method for producing a silane-modified silicate or a silane-modified water glass is carried out in such a way that a silane is at least partially hydrolyzed in the presence of a silicate compound or a water glass at a pH equal to or greater than 8, in particular greater than 11, to give a silane-modified silicate or water glass, and then the pH is set to values lower than 8.5, in particular lower than 8, preferably in the range from 4 to 7, in particular by adding acid.

It is also possible to set a pH value between 2 and 4 during acidification, which can be achieved and maintained without causing precipitation or flocculation of the silane-modified silicate compound or silane-modified water glass.

A beneficial effect is already seen if only partial hydrolysis or condensation of silane occurs in the presence of silicates in aqueous solution in the alkali. Frequently, however, the hydrolysis or condensation of silane in the presence of silicates to form a silane-modified silicate compound or a silane-modified water glass is carried out completely in the alkaline. Partial hydrolysis of silane and silicate in aqueous alkaline solution can be continued after acidification to a pH of 7 or less, up to complete hydrolysis if desired.

Also according to this embodiment, in particular the previously mentioned compounds lithium water glass, sodium water glass, potassium water glass and mixtures thereof are used as water glass or silicate, preferably sodium water glass, potassium water glass and mixtures thereof.

For producing silane-modified silicate compounds or water glasses, an epoxy-functional, phenoxy-functional, vinyl-functional or amino-functional silane is advantageously used. More preferably, silanes comprising at least one Si—C bond, i.e. a bond between a silicon and a carbon atom, are used. Different silanes can be used with each other in admixture. Particularly suitable silanes are methacryloxymethyltrimethoxysilane, methacryloxymethyltriethoxysilane, 3-aminopropylmethyldimethoxy silane, 3-aminopropyltriethoxysilane, N-(2-aminoethyl)-3-aminopropylmethyldimethoxy silane, and 3-mercaptopropyltrimethoxysilane, N-(2-aminoethyl)-3-aminopropyltrimethoxysilane, N-(2-aminoethyl)-3-aminopropyl-trimethoxysilane, N-cyclohexyl-3-aminopropyltrimethoxysilane, N-cyclohexylamino-methyltriethoxysilane, 3-aminopropyltriethoxysilane, 3-(2-aminomethylamino)propyltriethoxysilane, N-(2-aminoethyl)-3-aminopropylmethyldimethoxysilane, 3-aminopropyltrimethoxysilane, 3-ureidopropyltrimethoxysilane, vinyltrimethoxysilane, vinyldimethoxymethylsilane, vinyltriethoxysilane, vinyltriacetoxysilane, 3-methacryloxypropyltrimethoxysilane, methacryloxymethyl)methyldimethoxysilane, methacryloxymethyltrimethoxysilane, 3-methacryloxypropyltriacetoxysilane, N-methyl[3-(trimethoxysilyl)propyl]carbamate, N-trimethoxysilylmethyl-0-methylcarbamate, N-dimethoxy(methyl)silylmethyl-0-methylcarbamate, tris-[3-(trimethoxysilyl)propyl]-isocyanurate, 3-glycidoxypropyltrimethoxysilane, 3-glycidoxypropyltriethoxysilane, methyltrimethoxysilane, methyltriethoxysilane, dimethyldimethoxysilane, dimethyldiethoxysilane, trimethylethoxysilane, isooctyltrimethoxysilane, isooctyltriethoxysilane, hexadecyltrimethoxysilane, (cyclohexyl)methyldimethoxysilane, dicyclopentyldimethoxysilane, phenyltriethoxysilane, triacetoxyethylsilane, 1,2-bis(triethoxysilyl)ethane.

In producing the silane-modified silicates, silane and silicate are each advantageously used in a weight ratio of 2:1 to 1:10, in particular 1:1 to 1:5, preferably 1:1 to 1:3, preferred 1:1 to 1:2. The silane can be used as a single compound or as a mixture of silanes, and the same applies to the silicate. For further details on producing silane-modified silicates or water glasses, reference can be made to WO 2016/107791 A1, the disclosed content of which is fully encompassed by the present invention.

If a mixture of organic and inorganic binding agents is used in the context of the present invention, particularly good results are obtained if the inorganic and organic binding agents are used in a specific weight ratio to each other. Particularly good results are obtained in the context of the present invention if the weight ratio of inorganic binding agent to organic binding agent varies in the range of 1:1.2 to 3:1, in particular 1:1 to 2:1, preferably 1.1:1 to 1.8:1, preferred 1.1:1 to 1.4:1 based on the weight of inorganic binding agent and the weight of organic binding agent in the coating composition. Thus, in the context of the present invention, it is preferential if a certain excess of inorganic binding agent is used.

As previously stated, the coating composition includes a lubricant. The lubricant is preferably selected from the group consisting of organic lubricants, inorganic lubricants and mixtures thereof. However, particularly good results are obtained in the context of the present invention if the lubricant is an organic lubricant.

The lubricants used in the context of the present invention are usually in particulate form. In this regard, the lubricants typically comprise absolute particle sizes in the micrometer range.

In the context of the present invention, particularly good results are obtained if the lubricant is selected from the group consisting of waxes, plastic particles, in particular polyetherketone (PEK), polyetheretherketone (PEEK), polyphenylene sulfide (PPS), polyethersulfone (PES), polyetherimide (PEI), polyamideimide (PAI) and mixtures thereof, micronized sulfur and mixtures thereof. Particularly good results are obtained in the context of the present invention if the lubricant is a wax.

If the lubricant is a wax, it has been well proven if the wax is selected from the group consisting of natural waxes, semi-synthetic waxes, synthetic waxes and mixtures thereof. Preferably, the wax is a synthetic wax.

Similarly, it is preferred in the context of the present invention if the wax is selected from the group consisting of beeswax, carnauba wax, montan wax, modified montan wax, amide wax, polypropylene wax, polyethylene wax, HDPE wax (high-density polyethylene wax), oxidized HDPE wax, ethylene vinyl acetate wax, polyethylene glycol wax, polyester wax, Fischer-Tropsch wax and mixtures thereof, preferably polypropylene wax, polyethylene wax, HDPE wax, oxidized HDPE wax, ethylene vinyl acetate wax, polyethylene glycol wax, polyester wax, Fischer-Tropsch wax and mixtures thereof.

Particularly good results are obtained in this context if the wax is selected from the group consisting of polypropylene wax, polyethylene wax, HDPE wax, oxidized HDPE wax, Fischer-Tropsch wax and mixtures thereof.

Even more preferably in the context of the present invention the wax is a polyethylene wax (PE wax).

With waxes, in particular synthetic waxes, preferably polyethylene wax, as lubricants, the sliding and frictional properties of the coating composition in particular can be excellently set. In particular, combinations of an organic binding agent, an inorganic binding agent, a wax-based lubricant and platelet-shaped pigments exhibit excellent and consistent coefficients of friction, in particular even with multiple tightening and under thermal stress.

Now, as to the amount in which the coating composition contains the lubricant, this is at least 1.3 wt. %, based on the coating composition. However, it has been found to be advantageous if the coating composition contains the lubricant in amounts of more than 1.3 wt. %, in particular more than 2 wt. %, preferably more than 3 wt. %, more preferably more than 4 wt. %, in particular more preferably more than 4.5 wt. %, based on the coating composition.

Similarly, good results are obtained if the coating composition contains the lubricant in amounts of less than 20 wt. %, in particular less than 15 wt. %, preferably less than 12 wt. %, more preferably less than 8 wt. %, based on the coating composition.

Furthermore, it is preferred in the context of the invention if the coating composition contains the lubricant in amounts of 1.3 to 20 wt. %, in particular 2 to 15 wt. %, preferably 3 to 12 wt. %, more preferably 4 to 10 wt. %, particularly preferably 4.5 to 8 wt. %, based on the coating composition.

In the context of the present invention, it is advantageously provided that the coating composition is free of fluorine-containing compounds, in particular free of organic fluorine-containing compounds. Even more preferably, it is provided in the context of the present invention that the coating composition is free of fluorinated polymer particles, in particular is free of PTFE and PVDF.

It is a great advantage of the present invention that coating compositions with selectively adjustable coefficients of friction can be provided which do not involve the use of fluorinated polymer particles of concern. In particular, it is possible in the context of the present invention to provide coating compositions with excellent sliding and frictional properties which can be used completely without the use of fluorinated organic compounds. Furthermore, within the scope of the present invention, it is possible to significantly reduce the variance of the coefficient of friction, i.e. the variation of the measured coefficient of friction values for a coating composition compared to coating compositions containing fluorinated polymer particles.

Furthermore, it is within the scope of the present invention that the coating composition contains platelet-shaped particles. It has been well proven if the platelet-shaped particles are selected from the group of metal flakes, graphene, graphite, boron nitride, molybdenum disulfide, glass flakes, layered silicates and mixtures thereof. The layered silicates are preferably selected from the group of mica, talc, bentonite, kaolin and mixtures thereof. In this context, the metal flakes are preferably selected from the group of aluminum flakes, zinc flakes, copper flakes and mixtures thereof.

Preferentially, the platelet-shaped particles are metal flakes, in particular selected from the group of aluminum flakes, zinc flakes, copper flakes and mixtures thereof. It is more preferably if the platelet-shaped particles are aluminum flakes.

Preferentially, the coating composition comprises the platelet-shaped particles in amounts of 3 to 15 wt. %, in particular 4 to 12 wt. %, preferably 4 to 10 wt. %, preferred 5 to 8 wt. %, based on the coating composition.

By using platelet-shaped particles in the coating composition, the coefficients of friction and the sliding properties of the coated substrates can be set precisely and, in particular, the stick-slip effect can be avoided even better. Furthermore, it is also possible to cure the coating composition at high temperatures without observing an increase in the coefficient of friction.

Particularly good results are obtained if the weight ratio of platelet-shaped particles to lubricant varies in the range from 0.8:1 to 1.8:1, in particular 1:1 to 1.6:1, preferably 1.1:1 to 1.4:1, based on the weight of platelet-shaped particles and the weight of lubricant in the coating composition.

Furthermore, very good results are obtained if specific ratios of platelet-shaped particles to binding agent are present. Thus, it has been well proven if weight-based ratios of platelet-shaped particles to binding agent are in the range of 1:2 to 1:17, in particular 1:2.4 to 1:9, preferably 1:2.5 to 1:4, preferred 1:2.7 to 1:3.2, based on the weight of platelet-shaped particles and the weight of binding agent in the coating composition.

In the context of the present invention, it may further be provided that the coating composition comprises at least one thickener and/or rheology additive.

Thickeners and/or rheological additives serve in particular to set the viscosity as well as the flow or even the layer thickness with which the composition according to the invention can be applied to a substrate.

If the coating composition contains a thickener and/or a rheological additive, the coating composition usually contains the thickener and/or the rheological additive in amounts of 0.01 to 5 wt. %, in particular 0.05 to 3 wt. %, preferably 0.1 to 2 wt. %, based on the coating composition.

The thickener and/or the rheological additive can be selected from a variety of suitable compounds and compound classes. However, it has been well proven if the thickener and/or the rheological additive is selected from the group of ethyl cellulose, silicic acid, silicates and mixtures thereof. More preferably, the thickener and/or the rheological additive is silicic acid, in particular fumed silica.

According to a further preferred embodiment of the present invention, the coating composition comprises
(a) a binding agent,
(b) a lubricant, in particular a wax, in amounts of at least 1.3 wt. %, based on the coating composition
(c) platelet-shaped particles, in particular metal flakes, and
(d) a thickener and/or a rheological additive.

For this preferred embodiment of the present invention, all the advantages, features and special characteristics previously mentioned in context with the further embodiments and features of the coating composition according to the invention apply accordingly.

In addition, it may be provided that the coating composition comprises at least one further additive.

If the coating composition comprises a further additive, the coating composition comprises the further additive in amounts of 0.01 to 5 wt. %, in particular 0.05 to 3 wt. %, preferably 0.1 to 2 wt. %, based on the coating composition.

Particularly good results are obtained in this context if the further additive is selected from the group consisting of wetting agents, preservatives, stabilizers, acids and/or bases, defoaming components, film formers, leveling agents, UV absorbers, fillers, pH stabilizers and pH adjusting agents.

According to a preferred embodiment of the present invention, it is thus provided that the coating composition comprises
(a) a binding agent,
(b) a lubricant, in particular a wax, in amounts of at least 1.3 wt. %, based on the coating composition,
(c) platelet-shaped particles, in particular metal flakes,
(d) a thickener and/or a rheological additive, and
(e) a further additive.

For this particular and preferred embodiment of the present invention, all the advantages, features and special characteristics previously mentioned in context with the further embodiments and features of the present invention apply accordingly.

Furthermore, it may be provided that the coating composition comprises a filler.

If the coating composition comprises a filler, the coating composition typically comprises the filler in amounts of 1.3 to 50 wt. %, in particular 1 to 40 wt. %, preferably 5 to 35 wt. %, preferred 10 to 30 wt. %, based on the coating composition.

Particularly good results are obtained if the filler is selected from calcium carbonate, barium sulfate, talc and mixtures thereof.

According to a further embodiment of the present invention, it is thus provided that the coating composition comprises
(a) a binding agent,
(b) a lubricant, in particular a wax, in amounts of at least 1.3 wt. %, based on the coating composition,
(c) platelet-shaped particles, in particular metal flakes,
(d) a thickener and/or a rheological additive,
(e) a further additive, and
(f) a filler.

For this particular embodiment of the present invention, all of the advantages, features and specific characteristics previously mentioned in context with the other embodiments and features of the present invention apply accordingly.

As previously stated, best results are obtained in the context of the present invention if the coating composition comprises an organic binding agent and an inorganic binding agent. Thus, particularly good results are obtained in the context of the present invention if the coating composition comprises
(a1) an organic binding agent,
(a2) an inorganic binding agent
(b) a lubricant in amounts of at least 1.3 wt. %, based on the coating composition, and
(c) platelet-shaped particles.

The coating composition can contain the organic binding agent in almost any amounts. However, it has been well proven if the coating composition contains the organic binding agent in amounts of 2 to 20 wt. %, in particular 3 to 15 wt. %, preferably 4 to 12 wt. %, preferred 5 to 10 wt. %, based on the coating composition.

Furthermore, it has been well proven if the coating composition contains the inorganic binding agent in amounts of 4 to 20 wt. %, in particular 6 to 18 wt. %, preferably 7 to 15 wt. %, preferred 8 to 13 wt. %, based on the coating composition.

The use of an inorganic binding agent in particular increases the wear resistance and mechanical resistance of the coating. In addition, the use of inorganic coatings is also commercially desirable because they are often inexpensive to produce or obtain on a large industrial scale. If the coating composition includes an inorganic binding agent, the inorganic binding agent is typically a silicon-containing binding agent.

Furthermore, it has been well proven if the weight ratio of platelet-shaped particles to organic binding agent is in the range of 1:0.8 to 1:5, in particular 1:1 to 1:3, preferably 1:1 to 1:2, preferred 1:1.1 to 1:1.4, based on the weight of platelet-shaped particles and the weight of organic binding agent in the coating composition.

Similarly, it has been well proven if the weight ratio of platelet-shaped particles to inorganic binding agent is in the range of 1:1.2 to 1:12, in particular 1:1.4 to 1:6, preferably 1:1.5 to 1:2, preferred 1:1.6 to 1:1.8, based on the weight of platelet-shaped particles and the weight of inorganic binding agent in the coating composition.

For this preferred embodiment of the present invention, all the advantages, features and special characteristics previously mentioned in context with the further embodiments and features of the coating composition according to the invention apply accordingly.

According to a further preferential embodiment of the present invention, the coating composition comprises
(a1) an organic binding agent, in particular wherein the organic binding agent comprises a polymer selected from the group consisting of acrylates and acrylate copolymers,
(a2) an inorganic binding agent, in particular a silicon-containing binding agent,
(b) a lubricant, in particular a wax, in amounts of at least 1.3 wt. %, based on the coating composition,
(c) platelet-shaped particles, in particular metal flakes, and
(d) a thickener and/or a rheological additive.

For this preferred embodiment of the present invention, all the advantages, features and special characteristics previously mentioned in context with the further embodiments and features of the coating composition according to the invention apply accordingly.

According to a further preferential embodiment of the present invention, the coating composition comprises
(a1) an organic binding agent, in particular wherein the organic binding agent comprises a polymer selected from the group consisting of acrylates and acrylate copolymers,
(a2) an inorganic binding agent, in particular a silicon-containing binding agent,
(b) a lubricant, in particular a wax, in amounts of at least 1.3 wt. %, based on the coating composition,
(c) platelet-shaped particles, in particular metal flakes, and
(d) a thickener and/or a rheological additive, and
(e) a further additive.

For this preferred embodiment of the present invention, all the advantages, features and special characteristics previously mentioned in context with the further embodiments and features of the coating composition according to the invention apply accordingly.

According to a further preferential embodiment of the present invention, the coating composition comprises
(a1) an organic binding agent, in particular wherein the organic binding agent comprises a polymer selected from the group consisting of acrylates and acrylate copolymers,
(a2) an inorganic binding agent, in particular a silicon-containing binding agent,
(b) a lubricant, in particular a wax, in amounts of at least 1.3 wt. %, based on the coating composition,
(c) platelet-shaped particles, in particular metal flakes, and
(d) a thickener and/or a rheological additive, and
(e) a further additive, und
(f) a filler.

For this particular embodiment of the present invention, all advantages, features and special characteristics previously mentioned in context with the further embodiments and features of the present invention apply accordingly.

As previously stated, the composition according to the invention is an aqueous composition, that is, the composition according to the invention contains water as a solvent or dispersant. Typically, the composition according to the invention contains water in amounts of 40 to 98 wt. %, in particular 50 to 95 wt. %, preferably 60 to 90 wt. %, preferred 60 to 85 wt. %, based on the coating composition.

In addition, the coating composition preferably comprises only small amounts of organic solvents and volatile organic compounds (VOCs). Typically, the coating composition contains organic solvents and volatile organic compounds in amounts of less than 3 wt. %, in particular less than 1 wt. %, preferably less than 0.5 wt. %, more preferably less than 0.3 wt. %, in particular preferably less than 0.1 wt. %, based on the coating composition. Preferably, the coating composition is free of organic solvents and volatile organic compounds.

Now, as far as the viscosity of the coating composition according to the invention is concerned, this can vary within wide ranges. However, particularly good results are obtained in the context of the present invention if the coating composition comprises a Brookfield dynamic viscosity at 20° C. in the range from 2 to 5,000 mPas, in particular from 5 to 1,000 mPas, preferably from 5 to 500 mPas, more preferably from 10 to 100 mPas, in particular preferably from 30 to 50 mPas. With viscosities in the above-mentioned ranges, particularly thin and uniform topcoat coatings can be obtained.

Further subject-matter of the present invention—according to a second aspect of the present invention—is the use of an aforementioned coating composition as a topcoat for producing a coating with a selectively adjustable coefficient of friction on a metallic substrate, in particular a metallic substrate provided with a cathodic corrosion protection coating.

For further details on this aspect of the invention, reference can be made to the explanations on the other aspects of the invention, which apply in accordance with the use according to the invention.

Again, further subject-matter of the presentinvention—according to a third aspect of the present invention—is a method for producing a coating with a selectively adjustable coefficient of friction, wherein
(a) in a first method step, a substrate which is equipped at least in some areas with a cathodic corrosion protection coating is provided,
(b) in a second method step following the first method step (a), a coating composition according to one of the claims 1 to 14 is applied to the substrate at least in some areas, and
(c) in a third method step following the second method step (b), the coating composition applied in the second method step (b) is dried.

In the context of the present invention, it is preferred in particular if the coating composition applied to the substrate in the second method step (b) is cured and/or crosslinked in the third method step (c).

Typically, the substrate comprises a metal or consists of a metal. Preferably, the substrate consists of a metal. Particularly good results are obtained in this context if the metal is selected from the group consisting of iron, aluminum, magnesium and mixtures and alloys thereof.

In the context of the present invention, it is preferred if the metal is selected from iron and alloys thereof, in particular a steel.

In the context of the present invention, a substrate means an article that can be coated with the coating composition.

Typically, in the context of the present invention, the substrate is selected from sheets, moldings, small parts and mixtures thereof.

It is preferred in this context if the substrate is a small part, preferably mass bulk material, in particular selected from screws, nuts, bolts, washers, rivets and mixtures thereof.

It is preferred in the context of the present invention if the substrate is a screw or a nut, in particular a bolt.

The specific advantages of the coating composition according to the invention and the method according to the invention, namely the specific setting of the coefficient of friction, are particularly effective in the case of screws.

As far as the cathodic corrosion protection coating is concerned, which is applied to the substrate at least in some areas, preferably over the entire surface, this usually comprises a metal selected from the group consisting of zinc, aluminum, magnesium, nickel and mixtures and alloys thereof.

Preferably, the cathodic corrosion protection coating comprises zinc and alloys thereof.

It has been well proven in the context of the present invention if the cathodic corrosion protection coating is selected from the group of zinc-containing coatings, in particular electroplated zinc coatings, in particular electroplated zinc-nickel coatings, hot-dip galvanized coatings, zinc powder coatings, in particular zinc paints, and zinc flake coatings. Preferably, the cathodic corrosion protection coating is selected from the group of electroplated zinc coatings, in particular electroplated zinc-nickel coatings, zinc powder coatings and zinc flake coatings. Zinc powder coatings and zinc flake coatings may in particular also comprise zinc alloys. Preferably, the zinc alloys comprise aluminum and/or magnesium in addition to zinc, preferably aluminum and magnesium.

In the context of the present invention, it has been well proven if in method step (b) the coating composition is applied to the substrate or the cathodic corrosion protection coating with a layer thickness in the range from 1 to 12 μm, in particular 1 to 10 μm, preferably 1 to 8 μm, more preferably 2 to 8 μm, very preferably 2 to 7 μm.

The coating composition can be applied in method step (b) by any suitable method.

Usually, however, in method step (b) the coating composition is applied to the substrate using spraying, brushing, scraping, rolling, dipping or dip spinning. Particularly good results are obtained if in method step (b) the coating composition is applied using dipping or dip spinning. Dipping or dip spinning is suitable in particular for coating mass bulk materials, such as small parts. Within the scope of the present invention, it is preferred if the coating composition is applied over the entire surface of the substrate or the cathodic corrosion protection coating.

The temperature at which the coating composition is dried in method step (c) can vary over a wide range depending on the substrate selected, the cathodic corrosion protection coating applied thereto and the coating composition applied.

However, it has proven useful if in method step (c) the coating composition is dried at temperatures in the range from 20 to 300° C., in particular 30 to 250° C., preferably 40 to 200° C., preferred 50 to 180° C., even more preferably 55 to 160° C., most preferably 60 to 150° C.

At the above temperatures, rapid drying or curing and/or crosslinking of the binding agent systems usually takes place, wherein decomposition of the organic binding agent is avoided.

Similarly, it has been found convenient if in method step (c) the coating composition is dried for a period of 1 to 30 minutes, in particular 2 to 25 minutes, preferably 3 to 20 minutes, preferred 5 to 15 minutes.

As previously stated, it is possible within the scope of the present invention to set the coefficient of friction of the resulting coating, in particular of the topcoat, in a targeted manner. Particularly good results are thereby obtained if the coefficient of friction of the coated substrate is set in the range from 0.09 to 0.16, determined according to DIN EN ISO 16047:2013-01, by applying the coating composition. In particular, the friction coefficient is set by matching the individual components of the coating composition, in particular the amount of organic and inorganic binding agent, the type and amount of lubricant, and the amount of platelet-shaped particles.

For further details on this aspect of the invention, reference can be made to the previous explanations on the other aspects of the invention, which apply accordingly with respect to the use according to the invention.

Finally, further subject-matter of the present invention—according to a fourth aspect of the present invention—is a metallic substrate with a coating, which in particular is obtainable by means of a coating composition as described before or according to a method as described before, wherein the coating comprises a lubricant in amounts of at least 4.5 wt. %, based on the coating.

It has proved advantageous if the coating contains the lubricant in amounts of more than 4.5 wt. %, in particular more than 5 wt. %, preferably more than 10 wt. %, more preferably more than 12 wt. %, particularly preferably more than 15 wt. %, based on the coating.

Similarly, good results are obtained if the coating contains the lubricant in amounts of less than 35 wt. %, in particular less than 30 wt. %, preferably less than 25 wt. %, more preferably less than 22 wt. %, particularly preferably less than 20 wt. %, based on the coating.

Furthermore, it is preferred in the context of the invention if the coating contains the lubricant in amounts of 4.5 to 35 wt. %, in particular 5 to 30 wt. %, preferably 10 to 25 wt. %, more preferably 12 to 22 wt. %, particularly preferably 15 to 20 wt. %, based on the coating.

Usually, the substrate still comprises a cathodic corrosion protection coating between the coating, in particular the topcoat, in particular in the form of a basecoat.

In this case, the coating, in particular the topcoat, preferably comprises a layer thickness in the range from 1 to 10 μm, in particular 1 to 8 μm, preferably 1 to 7 μm, more preferably 2 to 7 μm, particularly preferably 2 to 6 μm

Typically, the coating, in particular the topcoat, contains the binding agent in amounts of 30 to 90 wt. %, in particular 39 to 90 wt. %, preferably 45 to 80 wt. %, more preferably 50 to 70 wt. %, particularly preferably 55 to 65 wt. %, based on the coating, in particular the topcoat.

If a mixture of organic and inorganic binding agents is used within the scope of the present invention, it has been well proven if the coating, in particular the topcoat, contains the organic binding agent in amounts of 5 to 35 wt. %, in particular 9 to 35 wt. %, preferably 15 to 32 wt. %, more preferably 20 to 30 wt. %, particularly preferably 25 to 30 wt. %, based on the coating, in particular the topcoat.

Likewise, it is preferred in the context of the present invention if the coating, in particular the topcoat, contains the inorganic binding agent in amounts of 25 to 75 wt. %, in particular 30 to 60 wt. %, preferably 30 to 50 wt. %, more preferably 30 to 40 wt. %, particularly preferably 32 to 35 wt. %, based on the coating, in particular the topcoat.

It is further well proven if the ratio by weight of inorganic binding agent to organic binding agent is in the range of 1:1 to 2.25:1, in particular 1.1:1 to 2.0:1, preferably 1.2:1 to 1.5:1, based on the weight of inorganic binding agent and the weight of organic binding agent in the coating, in particular the topcoat.

It is also preferred if the coating, in particular the topcoat, contains the platelet-shaped particles in amounts of 1 to 30, in particular 10 to 30 wt. %, preferably 15 to 25 wt. %, more preferably 17 to 22 wt. %, based on the coating.

Particularly good results are obtained if the weight ratio of platelet-shaped particles to lubricant is in the range from 0.8:1 to 1.8:1, in particular 1:1 to 1.6:1, preferably 1.1:1 to 1.4:1, based on the weight of platelet-shaped particles and the weight of lubricant in the coating, in particular the topcoat.

Furthermore, very good results are obtainable if special ratios of platelet-shaped particles to binding agent are present. Thus, it has been well proven if weight-related ratios of platelet-shaped particles to binding agent are in the range of 1:2 to 1:17, in particular 1:2.4 to 1:9, preferably 1:2.5 to 1:4, preferred 1:2.7 to 1:3.2, based on the weight of platelet-shaped particles and the weight of binding agent in the coating, in particular the topcoat.

If the coating contains a mixture of organic and inorganic binding agents, it has been well proven if the weight ratio of platelet-shaped particles to organic binding agent is in the range of 1:0.8 to 1:5, in particular 1:1 to 1:3, preferably 1:1 to 1:2, preferred 1:1.1 to 1:1.4, based on the weight of platelet-shaped particles and the weight of organic binding agent in the coating, in particular the topcoat.

Similarly, it has been well proven if the weight ratio of platelet-shaped particles to inorganic binding agent is in the range of 1:1.2 to 1:12, in particular 1:1.4 to 1:6, preferably 1:1.5 to 1:2, preferred 1:1.6 to 1:1.8, based on the weight of platelet-shaped particles and the weight of inorganic binding agent in the coating, in particular the topcoat.

Furthermore, it is preferred if the coefficient of friction of the coated substrate varies in the range from 0.09 to 0.16, determined according to DIN EN ISO 16047:2013-01.

For further details on the substrate according to the invention, reference can be made to the above explanations on the other aspects of the invention, which apply accordingly with respect to the substrate according to the invention.

The subject-matter of the present invention is clarified below with reference to the working examples in an illustrative and non-limiting manner.

### Working Examples

To further illustrate the present invention and its advantages, series of tests are carried out with topcoat compositions according to the invention. For this purpose, the coating composition is first applied to screws and cured. The sliding and frictional properties of the screws are then determined. The results are then compared with the coefficients of friction of coated screws coated with prior art topcoat compositions containing PTFE.

Topcoat According to the Invention

The coating composition 1 according to the invention for producing a topcoat 1 comprises a pure acrylate as organic binding agent and a mixture of silane hydrolysate and lithium water glass as inorganic binding agent. The coating composition 1 further comprises a micronized PE wax as a lubricant and aluminum flakes as platelet-shaped particles and further additives.

The composition is shown in Table 1 below.

TABLE 1
Coating composition according to the invention 1

| | |
|---|---|
| Composition | 1 |

| | | |
|---|---|---|
| Acrylic dispersioncv(50% solid content) | [wt. %] | 16 |
| Lithium water glass (25% solid content) | [wt. %] | 37 |
| Silane hydrolyzate | [wt. %] | 3 |
| Micronized PE-wax | [wt. %] | 5 |
| Aluminum flakes | [wt. %] | 9 |
| Defoamer | [wt. %] | 0.2 |
| Thickener | [wt. %] | 0.3 |
| Wetting agent | [wt. %] | 0.5 |
| Water | [wt. %] | Ad 100 |

Comparison of a topcoat according to the invention with a topcoat containing PTFE.

In each case, five M 10×65 screws designed as internal supports are first coated with a zinc flake basecoat without lubricating and sliding properties (product DELTA-PROTEKT KL 120 from Dörken) and with a layer thickness of 10 μm.

Subsequently, a topcoat according to the invention or a topcoat containing PTFE is applied to the screws coated in this way and cured. The layer thickness in each case is approx. 3 μm. The product DELTA-PROTEKT VH 301.1 GZ, which comprises a mixture of an inorganic and an organic binding agent and PTFE particles as lubricant, from Dörken is used as the PTFE-containing topcoat.

Subsequently, the coefficient of friction is determined in accordance with DIN EN ISO 16047:2013-01 with steel as the mating surface. The bolts are tightened and loosened five times each. The coefficients of friction are measured at the head (μ_{head}) and at the thread (μ_{thread}) and then the total coefficient of friction (μₜₒₜₐₗ) is determined.

The individual measured values are shown in Table 2 for the topcoat according to the invention and in Table 3 for the comparison.

TABLE 2
Friction coefficients of screws coated with
the topcoat according to the invention

| | tightening # | Screw 1 | Screw 2 | Screw 3 | Screw 4 | Screw 5 |
|---|---|---|---|---|---|---|
| μₜₒₜₐₗ | 1 | 0.135 | 0.135 | 0.132 | 0.131 | 0.136 |
| | 2 | 0.137 | 0.132 | 0.137 | 0.133 | 0.137 |
| | 3 | 0.138 | 0.133 | 0.136 | 0.132 | 0.135 |
| | 4 | 0.136 | 0.131 | 0.132 | 0.130 | 0.134 |
| | 5 | 0.136 | 0.133 | 0.128 | 0.128 | 0.134 |
| μ_{thread} | 1 | 0.140 | 0.140 | 0.138 | 0.142 | 0.144 |
| | 2 | 0.138 | 0.132 | 0.138 | 0.134 | 0.134 |
| | 3 | 0.138 | 0.131 | 0.138 | 0.133 | 0.137 |
| | 4 | 0.136 | 0.130 | 0.137 | 0.133 | 0.136 |
| | 5 | 0.136 | 0.131 | 0.137 | 0.132 | 0.137 |
| μ_{head} | 1 | 0.131 | 0.131 | 0.129 | 0.123 | 0.129 |
| | 2 | 0.136 | 0.132 | 0.137 | 0.133 | 0.134 |
| | 3 | 0.138 | 0.135 | 0.135 | 0.131 | 0.134 |
| | 4 | 0.136 | 0.131 | 0.128 | 0.128 | 0.133 |
| | 5 | 0.136 | 0.134 | 0.122 | 0.124 | 0.132 |

TABLE 3
Friction coefficients of screws coated
with a PTFE-containing topcoat

| | tightening # | Screw 1 | Screw 2 | Screw 3 | Screw 4 | Screw 5 |
|---|---|---|---|---|---|---|
| μₜₒₜₐₗ | 1 | 0.115 | 0.110 | 0.112 | 0.110 | 0.111 |
| | 2 | 0.126 | 0.129 | 0.129 | 0.120 | 0.133 |
| | 3 | 0.130 | 0.135 | 0.134 | 0.123 | 0.139 |
| | 4 | 0.132 | 0.138 | 0.137 | 0.127 | 0.142 |
| | 5 | 0.135 | 0.144 | 0.143 | 0.130 | 0.148 |
| μ_{thread} | 1 | 0.154 | 0.145 | 0.139 | 0.138 | 0.141 |
| | 2 | 0.157 | 0.160 | 0.160 | 0.145 | 0.160 |
| | 3 | 0.154 | 0.158 | 0.162 | 0.147 | 0.160 |
| | 4 | 0.155 | 0.155 | 0.159 | 0.148 | 0.159 |
| | 5 | 0.155 | 0.155 | 0.160 | 0.149 | 0.158 |
| μ_{head} | 1 | 0.088 | 0.086 | 0.093 | 0.090 | 0.090 |
| | 2 | 0.105 | 0.108 | 0.107 | 0.102 | 0.114 |
| | 3 | 0.113 | 0.119 | 0.115 | 0.106 | 0.125 |
| | 4 | 0.116 | 0.125 | 0.121 | 0.112 | 0.130 |
| | 5 | 0.121 | 0.136 | 0.131 | 0.116 | 0.141 |

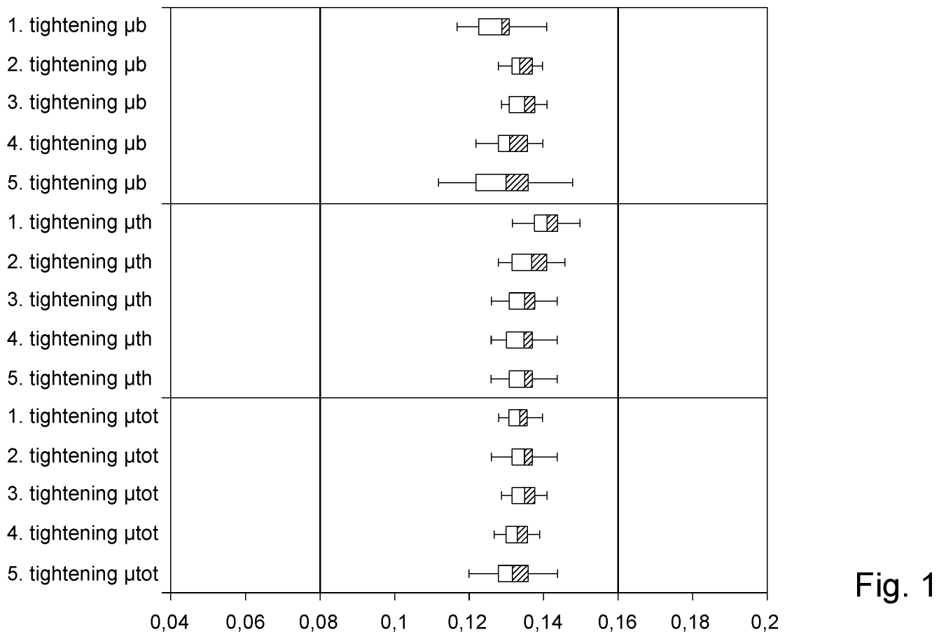

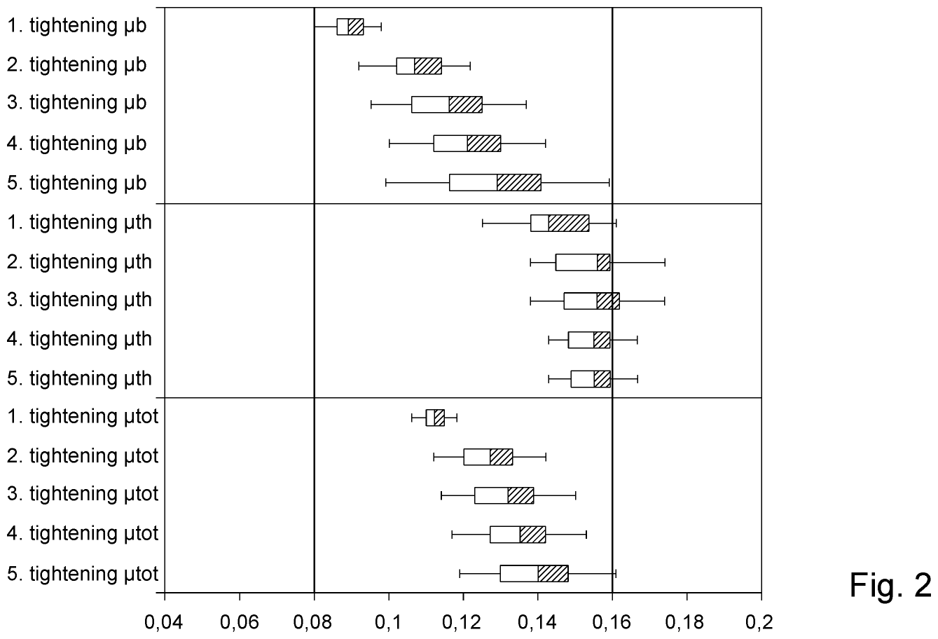

In FIGS. 1 and 2, the ranges of the measured values, the 25% percentiles of the median and the 75% percentiles are plotted against the measured values from Tables 2 and 3. In FIGS. 1 and 2, μ_{b} stands for the coefficient of friction measured at the head of the screw, μₜₕ for the coefficient of friction measured at the thread, and μₜₒₜ for the total coefficient of friction.

It can be seen that both the topcoat according to the invention (FIG. 1) and the PTFE-containing product of the prior art (FIG. 2) lie within the required coefficient of friction window of 0.09 to 0.16 both for the coefficient of friction determined at the screw head and at the screw thread and for the total coefficient of friction, wherein the topcoat according to the invention comprises a significantly lower scatter of the individual measured values than the product of the prior art.

Influence of the Baking Temperature

In a further series of tests, 5 M 10×65 bolts designed as inner beams are coated with a zinc flake basecoat (product DELTA-PROTEKT KL 100 from Dörken). After curing, the layer thickness is approx. 10 μm.

The screw coated in this way is then coated with coating composition 1 according to Table 1. The coating weight after curing is between 2.5 and 5 g/m2. The curing temperatures are varied between 60 and 200° C. and the curing time is 20 minutes in each case. Subsequently, the coefficient of friction is determined in accordance with DIN EN ISO 16047:2013-01 with steel as the counter layer. The data of the friction coefficient measurements are shown in Table 4.

TABLE 4
Influence of the baking temperature on the coefficient of friction

| G | T | | tightening 1 | tightening 2 | tightening 3 | tightening 4 | tightening 5 |
|---|---|---|---|---|---|---|---|
| 2.5 | 60 | μ_{head} | 0.09 | 0.10 | 0.10 | 0.11 | 0.11 |
| | | μ_{thread} | 0.11 | 0.12 | 0.12 | 0.12 | 0.12 |
| | | μₜₒₜₐₗ | 0.10 | 0.10 | 0.11 | 0.11 | 0.12 |
| 3.6 | 60 | μ_{head} | 0.10 | 0.11 | 0.12 | 0.12 | 0.12 |
| | | μ_{thread} | 0.11 | 0.12 | 0.12 | 0.12 | 0.12 |
| | | μₜₒₜₐₗ | 0.11 | 0.12 | 0.12 | 0.12 | 0.12 |
| 5 | 60 | μ_{head} | 0.08 | 0.09 | 0.09 | 0.10 | 0.10 |
| | | μ_{thread} | 0.10 | 0.11 | 0.11 | 0.12 | 0.12 |
| | | μₜₒₜₐₗ | 0.09 | 0.10 | 0.10 | 0.11 | 0.11 |
| 2.5 | 130 | μ_{head} | 0.10 | 0.11 | 0.12 | 0.12 | 0.13 |
| | | μ_{thread} | 0.12 | 0.12 | 0.12 | 0.12 | 0.12 |
| | | μₜₒₜₐₗ | 0.11 | 0.11 | 0.12 | 0.12 | 0.12 |
| 3.6 | 130 | μ_{head} | 0.11 | 0.12 | 0.13 | 0.13 | 0.13 |
| | | μ_{thread} | 0.11 | 0.12 | 0.12 | 0.12 | 0.12 |
| | | μₜₒₜₐₗ | 0.11 | 0.12 | 0.12 | 0.13 | 0.13 |
| 5 | 130 | μ_{head} | 0.08 | 0.09 | 0.09 | 0.10 | 0.10 |
| | | μ_{thread} | 0.11 | 0.11 | 0.11 | 0.12 | 0.12 |
| | | μₜₒₜₐₗ | 0.09 | 0.10 | 0.10 | 0.11 | 0.11 |
| 2.5 | 200 | μ_{head} | 0.12 | 0.13 | 0.14 | 0.14 | 0.14 |
| | | μ_{thread} | 0.13 | 0.13 | 0.13 | 0.13 | 0.13 |
| | | μₜₒₜₐₗ | 0.13 | 0.13 | 0.13 | 0.13 | 0.13 |
| 3.6 | 200 | μ_{head} | 0.11 | 0.12 | 0.12 | 0.12 | 0.12 |
| | | μ_{thread} | 0.13 | 0.13 | 0.13 | 0.12 | 0.12 |
| | | μₜₒₜₐₗ | 0.12 | 0.12 | 0.12 | 0.12 | 0.12 |
| 5 | 200 | μ_{head} | 0.09 | 0.11 | 0.11 | 0.12 | 0.12 |
| | | μ_{thread} | 0.13 | 0.13 | 0.13 | 0.14 | 0.14 |
| | | μₜₒₜₐₗ | 0.11 | 0.12 | 0.12 | 0.12 | 0.12 |

G: Layer weight in g/m²
T: baking temperature in ° C.

It can be seen that the coefficients of friction remain almost constant and do not increase at higher baking temperatures, as would be expected.

1. An aqueous coating composition for producing a coating with an adjustable coefficient of friction, the coating composition comprising:
an organic binding agent and/or inorganic binding agent;
a lubricant in amounts of at least 1.3 wt. %, based on the coating composition; and
platelet-shaped particles.

2. The coating composition according to claim 1, comprising the binding agent in amounts of 6 to 40 wt. % based on the coating composition.

3. The coating composition according to claim 1, wherein the coating composition comprises an organic and an inorganic binding agent.

4. The coating composition according to claim 1, wherein the organic binding agent comprises an organic polymer selected from the group of acrylates, polyurethanes, polyvinyl acetate and mixtures and copolymers thereof.

5. The coating composition according to claim 4, wherein the organic polymer is obtainable from monomers selected from the group of acrylic acid, esters of acrylic acid with C1- to C10-alcohols, methacrylic acid, esters of methacrylic acid with C1- to C10-alcohols, fumaric acid, maleic acid and mixtures and copolymers thereof.

6. The coating composition according to claim 1, wherein the inorganic binding agent is selected from silanes, silane hydrolysates, silicates, polysiliconates and mixtures thereof.

7. The coating composition according to claim 1, wherein the lubricant is selected from the group of organic lubricants, inorganic lubricants and mixtures thereof.

8. The coating composition according to claim 1, wherein the lubricant is selected from the group of waxes, plastic particles, micronized sulfur and mixtures thereof.

9. The coating composition according to claim 1, wherein the coating composition comprises the lubricant in amounts of 1.3 to 20 wt. % based on the coating composition.

10. The coating composition according to claim 1, wherein the platelet-shaped particles are selected from the group of metal flakes, graphene, graphite, boron nitride, molybdenum disulfide, glass flakes, layered silicates and mixtures thereof.

11. The coating composition according to claim 1, wherein the coating composition comprises the platelet-shaped particles in amounts of 3 to 15 wt. % based on the coating composition.

12. The coating composition according to claim 1, wherein the coating composition is free of fluorine-containing compounds.

13. A method comprising using the coating composition according to claim 1 as a topcoat for producing a coating with an adjustable coefficient of friction on a metallic substrate.

14. A method for producing a coating with a selectively adjustable coefficient of friction, the method comprising:
providing a substrate that is equipped at least in some areas with a cathodic corrosion protection coating;
applying the coating composition according to claim 1 to the substrate in the at least in some areas; and
drying the coating composition applied to the substrate.

15. The method according to claim 14, wherein the coefficient of friction of the substrate with the dried coating composition is set in the range from 0.09 to 0.16, determined according to DIN EN ISO 16047:2013-01.

16. A metallic substrate with a coating comprising the coating composition according to claim 1 wherein the coating comprises a lubricant in amounts of at least 4.5 wt. %, based on the coating.

17. The metallic substrate according to claim 16, wherein the coating comprises the lubricant in amounts of 4.5 to 35 wt. % based on the coating.

18. The metallic substrate according to claim 16, wherein the coating comprises the platelet-shaped particles in amounts of 1 to 30 based on the coating.
